(19) United States
(12) Patent Application Publication
(10) Pub. No.: US 2010/0103573 A1
(43) Pub. Date: Apr. 29, 2010

(54) Semiconductor package having electrostatic protection circuit for semiconductor package including multiple semiconductor chips

(75) Inventor: Kou Sasaki, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kanagawa (JP)

(21) Appl. No.: 12/585,446

(22) Filed: Sep. 15, 2009

(30) Foreign Application Priority Data
Oct. 23, 2008 (JP) 2008-272679

(51) Int. Cl. H02H 9/04

(52) U.S. Cl. 361/56

(57) ABSTRACT

A semiconductor package includes: a first semiconductor chip; a first internal circuit which operates, in the first semiconductor chip, at a voltage applied between a first high-potential side power supply terminal and a first low-potential side power supply terminal; a second semiconductor chip; a second internal circuit which operates, in the second semiconductor chip, at a voltage applied between a second high-potential side power supply terminal and a second low-potential side power supply terminal; and a first electrostatic protection circuit which is formed in the first semiconductor chip, and which has one end connected to a node between the first internal circuit and the first low-potential side power supply terminal and has the other end connected to a node between the second internal circuit and the second low-potential side power supply terminal.

### INCORPORATION BY REFERENCE

This application is based upon and claims the benefit of priority from Japanese Patent Application No. 2008-272679 which was filed on Oct. 23, 2008, the disclosure of which is incorporated herein in its entirety by reference.

### BACKGROUND OF THE INVENTION

1. Field of the Invention

The present invention relates to a semiconductor package, and, more particularly, to a semiconductor package including multiple chips.

2. Description of Related Art

Recently, system-mounting semiconductor packages such as SiP (System in Package), PoP (Package on Package), and MCP (Multi Chip Package) are employed to meet demands for miniaturization, higher performances, and higher integration of electrical devices. Any of such system-mounting semiconductor packages includes multiple chips. Here, each of the packaged chips includes a protection circuit against ESD (Electro Static Discharge) therein. However, it is hard to conclude that the measure against ESD across the connected multiple chips is sufficiently made. In this regard, Japanese Patent Application Laid Open No. 2007-200987 discloses a chip in which an ESD protection element is connected between multiple power supply systems. The literature also discloses that such a configuration is applicable to a device formed of multiple chips which have different power supply systems, respectively.

FIG. 14 illustrates a circuit diagram of an SiP including multiple chips of a related art. The SiP includes a package board 101, an LSI (Large Scale Integration) chip 121, an LSI chip 122, and an inter-chip ESD protection circuit 109. Here, the package board 101 includes power supply terminals T101, T102, ground terminals T103, 104, and a test terminal T105. Additionally, the LSI chip 121 includes an inter-power-supply ESD protection circuit 104a and test-terminal ESD protection circuits 103a, 105a. Moreover, the LSI chip 122 includes an inter-power-supply ESD protection circuit 104b and test-terminal ESD protection circuits 103b, 105b.

The inter-power-supply ESD protection circuit 104a of the LSI chip 121 is a protection circuit for ESD measure in a case where ESD is applied between the power supply terminal T101 and the ground terminal T103. Similarly, the inter-power-supply ESD protection circuit 104b of the LSI chip 122 is a protection circuit for ESD measure in a case where ESD is applied between the power supply terminal T102 and the ground terminal T104.

In addition, the test-terminal ESD protection circuit 103a is a protection circuit for ESD measure in a case where ESD is applied between the ground terminal T103 and the test terminal T105. Similarly, the test-terminal ESD protection circuit 103b is a protection circuit for ESD measure in a case where ESD is applied between the ground terminal T104 and the test terminal T105.

Furthermore, the test-terminal ESD protection circuit 105a is a protection circuit for ESD measure in a case where ESD is applied between the power supply terminal T101 and the test terminal T105. Similarly, the test-terminal ESD protection circuit 105b is a protection circuit for ESD measure in a case where ESD is applied between the power supply terminal T102 and the test terminal T105.

The above-described ESD protection circuits are ESD protection circuits for the corresponding chips and are formed inside the chips. On the other hand, the inter-chip ESD protection circuit 109 is a protection circuit for ESD measure in a case where ESD is applied between terminals across the two LSI chips, for example, between the power supply terminal T101 and the power supply terminal T102. If the inter-chip ESD protection circuit 109 is not provided, then internal circuits (unillustrated) inside the LSI chips 121, 122 are possibly broken when ESD is applied between the terminals across the two chips. In other words, the inter-chip ESD protection circuit 109 can prevent electrostatic breakdown that occurs otherwise in the above case. At the same time, the inter-chip ESD protection circuit 109 can block noise between the chips.

### SUMMARY

However, the inter-chip ESD protection circuit 109 is a component which is different from the LSI chips 121, 122. Accordingly, it is required to include a step of mounting the inter-chip ESD protection circuit 109 on the package board 101. Moreover, the yield in this mounting step may decrease the total yield of the package product. In addition, a space for the mounting is required, which contradicts the miniaturization trend.

In a first exemplary aspect of the present invention, there is provided.

a semiconductor package that includes:

a first semiconductor chip;

a first internal circuit which operates, in the first semiconductor chip, at a voltage applied between a first high-potential side power supply terminal and a first low-potential side power supply terminal;

a second semiconductor chip;

a second internal circuit which operates, in the second semiconductor chip, at a voltage applied between a second high-potential side power supply terminal and a second low-potential side power supply terminal; and

a first electrostatic protection circuit which is formed in the first semiconductor chip, and which has one end connected to a node between the first internal circuit and the first low-potential side power supply terminal and has the other end connected to a node between the second internal circuit and the second low-potential side power supply terminal.

By forming an electrostatic breakdown protection element inside the first semiconductor chip, it is made possible to provide a high-yield and small-sized semiconductor package capable of preventing: electrostatic breakdown across multiple chips; and a noise between the chips.

Another aspect of the present invention is a semiconductor package that includes:

a first semiconductor chip;

a first internal circuit which operates, in the first semiconductor chip, at a voltage applied between a first high-potential side power supply terminal and a first low-potential side power supply terminal;

a second semiconductor chip; and

a second internal circuit which operates, in the second semiconductor chip, at a voltage applied between a second high-potential side power supply terminal and a second low-potential side power supply terminal, wherein

a first signal terminal of the first semiconductor chip is connected to a node between the second internal circuit and the second low-potential side power supply terminal, and

a second signal terminal of the second semiconductor chip is connected to a node between the first internal circuit and the first low-potential side power supply terminal.

By connecting the signal terminal of one of the semiconductor chips and the low-potential side power supply terminal of the other semiconductor chip to each other, it is made possible to provide a high-yield and small-sized semiconductor package capable of preventing: electrostatic breakdown across multiple chips; and a noise between the chips.

According to the present invention, it is possible to provide a high-yield and small-sized semiconductor package capable of preventing: electrostatic breakdown across multiple chips; and a noise between the chips.

### BRIEF DESCRIPTION OF THE DRAWINGS

The above and other exemplary aspects, advantages and features of the present invention will be more apparent from the following description of certain exemplary embodiments taken in conjunction with the accompanying drawings, in which:

FIG. 1 is a circuit diagram of an SiP according to a first exemplary embodiment;

FIG. 2 is a side view of the SiP according to the first exemplary embodiment;

FIG. 3 is an example of ESD protection circuits;

FIG. 4 is an example of ESD protection circuits;

FIG. 5 is an example of ESD protection circuits;

FIG. 6 is an example of ESD protection circuits;

FIG. 7 is an example of ESD protection circuits;

FIG. 8 is a circuit diagram of an SiP according to a comparative example;

FIG. 9 is a graph for illustrating a mechanism of preventing electrostatic breakdown;

FIG. 10 is a side view of an SiP according to the first exemplary embodiment;

FIG. 11 is a circuit diagram of a PoP according to a second exemplary embodiment;

FIG. 12 is a side view of the PoP according to the second exemplary embodiment;

FIG. 13 is a circuit diagram of an SiP according to a third exemplary embodiment; and

FIG. 14 is a diagram for illustrating a problem of a related art.

### DETAILED DESCRIPTION OF THE EXEMPLARY EMBODIMENTS

### First Exemplary Embodiment

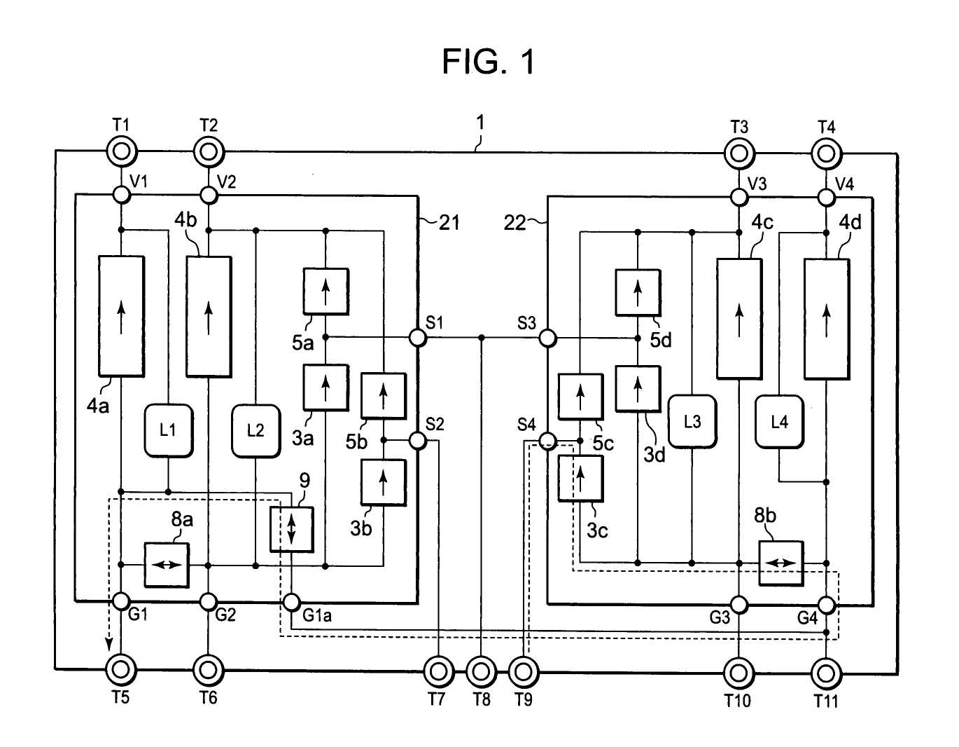

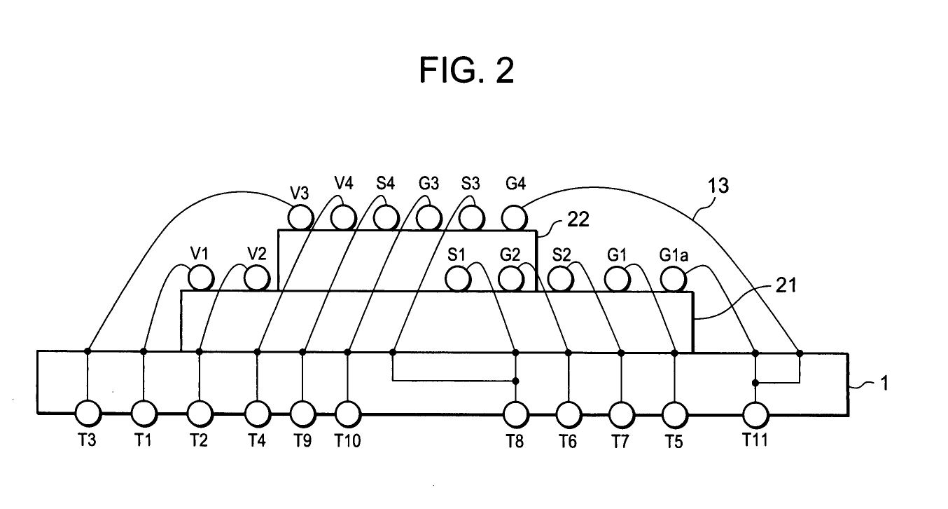

FIG. 1 is a circuit diagram of an SiP according to a first exemplary embodiment. FIG. 2 is a side view of the SiP according to the first exemplary embodiment. As shown in FIG. 1 and FIG. 2, the SiP includes a package board 1, an LSI chip 21, and an LSI chip 22. A signal terminal S1 of the LSI chip 21 and a signal terminal S3 of the LSI chip 22 are connected to each other, so that signals are transmitted and received between the LSI chips. As shown in FIG. 2, the LSI chip 21 is mounted on the package board 1, and the LSI chip 22 is further mounted on the LSI chip 21. Note that an encapsulation resin is omitted in FIG. 2.

Here, the package board 1 includes power supply terminals T1 to T4, ground terminals T5, T6, T10, T11, input-output terminals T7, T9, and a test terminal T8. In addition, the LSI chip 21 includes inter-power-supply ESD protection circuits 4a, 4b, internal circuits L1, L2, test-terminal ESD protection circuits 3a, 5a, input-output-terminal ESD protection circuits 3b, 5b, an ESD protection circuit 8a between different power supplies, and an inter-chip ESD protection circuit 9. Moreover, the LSI chip 22 includes inter-power-supply ESD protection circuits 4c, 4d, internal circuits L3, L4, test-terminal ESD protection circuits 3d, 5d, input-output-terminal ESD protection circuits 3c, 5c, and an ESD protection circuit 8b between different power supplies.

The power supply terminals T1 to T4 are terminals to which power supply potentials are applied after the SiP is mounted on an electronic device. Moreover, as shown in FIG. 2, the power supply terminals T1 to T4 are formed on the back surface of the package board 1, and are respectively connected to terminals V1, V2 of the LSI chip 21 and terminals V3, V4 of the LSI chip 22 through a through hole, a wiring on the package board 1, a bonding wire 13, or the like. Here, different power supply potentials are applied to the power supply terminal T1 and the power supply terminal T2. Similarly, different power supply potentials are applied to the power supply terminal T3 and the power supply terminal T4. For example, VDD1 is applied to the power supply terminals T1, T3 while VDD2 is applied to the power supply terminals T2, T4.

The ground terminals T5, T6, T10, T11 are terminals to which ground potentials are applied after the SiP is mounted on an electronic device. Moreover, as shown in FIG. 2, the ground terminals T5, T6, T10, T11 are formed on the back surface of the package board 1, and are respectively connected to terminals G1, G2 of the LSI chip 21 and terminals G3, G4 of the LSI chip 22 through a through hole, a wiring on the package board 1, a bonding wire 13, or the like.

The internal circuit L1 of the LSI chip 21 is a circuit which operates at a voltage applied between the power supply terminal T1 and the ground terminal T5. The inter-power-supply ESD protection circuit 4a is connected to the internal circuit L1 in parallel so as to be reverse biased between the power supply terminal T1 and the ground terminal T5. As the inter-power-supply ESD protection circuit 4a, for example, a circuit as shown in FIG. 4 can be used in which a source of a diode-connected N-channel MOS (Metal Oxide Semiconductor) transistor NM is connected to a drain of a diode-connected P-channel MOS transistor PM, and in which a drain of the diode-connected N-channel MOS transistor NM is connected to a source of the diode-connected P-channel MOS transistor PM. The inter-power-supply ESD protection circuit 4a protects the internal circuit L1 when ESD is applied between the power supply terminal T1 and the ground terminal T5.

The internal circuit L2 of the LSI chip 21 is a circuit which operates at a voltage applied between the power supply terminal T2 and the ground terminal T6. The inter-power-supply ESD protection circuit 4b is connected to the internal circuit L2 in parallel so as to be reverse biased between the power supply terminal T2 and the ground terminal T6. As the inter-power-supply ESD protection circuit 4b, similar to the above-described inter-power-supply ESD protection circuit 4a, for example, the circuit shown in FIG. 4 can be used. The inter-power-supply ESD protection circuit 4b protects the internal circuit L2 when ESD is applied between the power supply terminal T2 and the ground terminal T6.

The ESD protection circuit 8a between different power supplies is a bidirectional diode which connects a power supply system including the voltage applied between the power supply terminal T1 and the ground terminal T5 to another power supply system including the voltage applied between the power supply terminal T2 and the ground terminal T6. As the ESD protection circuit 8a, for example, a circuit as shown in FIG. 6 can be used in which diodes D1, D2 directing in opposite directions to each other are connected in parallel. Alternatively, a resistor R as shown in FIG. 7 can be used. The ESD protection circuit 8a between different power supplies protects the internal circuits L1, L2 when ESD is applied between any one of the power supply terminal T1 and the ground terminal T5 and any one of the power supply terminal T2 and the ground terminal T6.

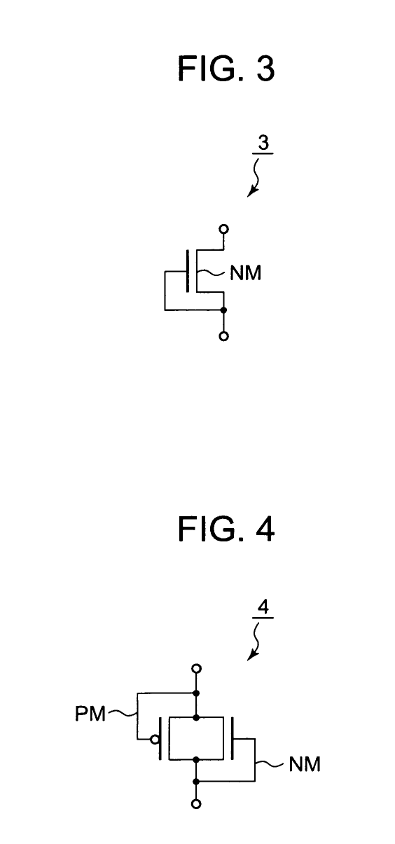

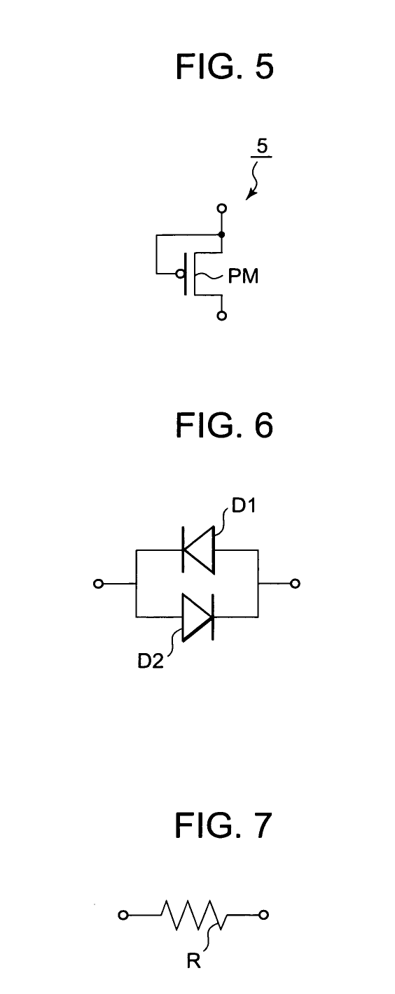

The test-terminal ESD protection circuits 3a and 5a are connected to each other in series. In addition, these serially-connected test-terminal ESD protection circuits 3a and 5a are connected to the internal circuit L2 in parallel so as to be reverse-biased between the power supply terminal T2 and the ground terminal T6. Moreover, a node between the test-terminal ESD protection circuits 3a and 5a is connected to the test terminal T8 of the package board 1 through the signal terminal S1 of the LSI chip 21. As the test-terminal ESD protection circuit 3a, for example, a diode-connected N-channel MOS transistor NM shown in FIG. 3 can be used. The test-terminal ESD protection circuit 3a protects the internal circuit L2 when ESD is applied between the test terminal T8 and the ground terminal T6. As the test-terminal ESD protection circuit 5a, for example, a diode-connected P-channel MOS transistor PM shown in FIG. 5 can be used. The test-terminal ESD protection circuit 5a protects the internal circuit L2 when ESD is applied between the test terminal T8 and the power supply terminal T2.

The input-output-terminal ESD protection circuits 3b and 5b are connected to each other in series. In addition, these serially-connected input-output-terminal ESD protection circuits 3b and 5b are connected to the internal circuit L2 in parallel so as to be reverse-biased between the power supply terminal T2 and the ground terminal T6. Moreover, a node between the input-output-terminal ESD protection circuits 3b and 5b is connected to the input-output terminal T7 of the package board 1 through a signal terminal S2 of the LSI chip 21. As the input-output-terminal ESD protection circuit 3b, for example, the diode-connected N-channel MOS transistor NM shown in FIG. 3 can be used. The input-output-terminal ESD protection circuit 3b protects the internal circuit L2 when ESD is applied between the input-output terminal T7 and the ground terminal T6. As the input-output-terminal ESD protection circuit 5b, for example, the diode-connected P-channel MOS transistor PM shown in FIG. 5 can be used. The input-output-terminal ESD protection circuit 5b protects the internal circuit L2 when ESD is applied between the input-output terminal T7 and the power supply terminal T2. Note that one input-output terminal for each chip 21, 22 is shown in FIG. 1 for simplification. When multiple input terminals are present, a pair of the input-output-terminal ESD protection circuits 3, 5 are provided for each input terminal.

The inter-chip ESD protection circuit 9 is a bidirectional diode which connects the LSI chip 21 to the LSI chip 22. One end of the inter-chip ESD protection circuit 9 is connected to a node between the inter-power-supply ESD protection circuit 4a and the terminal G1, whereas the other end of the inter-chip ESD protection circuit 9 is connected to a node between the ground terminal T11 and the terminal G4 of the LSI chip 22 through a terminal G1a. As the inter-chip ESD protection circuit 9, for example, the circuit as shown in FIG. 6 can be used in which the diodes D1, D2 directing in the opposite directions are connected to each other in parallel. Alternatively, the resistor R as shown in FIG. 7 can be used. The inter-chip ESD protection circuit 9 protects the internal circuits L1 to L4 when ESD is applied between any one of the power supply terminals T1, T2, the ground terminals T5, T6, and the input-output terminal T7 for the LSI chip 21 and any one of the power supply terminals T3, T4, the ground terminals T10, T11, the input-output terminal T9 for the LSI chip 22.

The inter-chip ESD protection circuit 9 according to the exemplary embodiment is formed inside the LSI chip 21. Accordingly, a step of mounting an inter-chip ESD protection circuit on the package board 1 is not needed. Thus, the total yield of the package product is also improved. In addition, a space for the mounting is not required, which results in the miniaturization. Moreover, at the same time, a noise between the chips can be blocked.

The internal circuit L3 of the LSI chip 22 is a circuit which operates at a voltage applied between the power supply terminal T3 and the ground terminal T10. The inter-power-supply ESD protection circuit 4c is connected to the internal circuit L3 in parallel so as to be reverse biased between the power supply terminal T3 and the ground terminal T10. As the inter-power-supply ESD protection circuit 4c, the circuit shown in FIG. 4 can be used. The inter-power-supply ESD protection circuit 4c protects the internal circuit L3 when ESD is applied between the power supply terminal T3 and the ground terminal T10.

The internal circuit L4 of the LSI chip 22 is a circuit which operates at a voltage applied between the power supply terminal T4 and the ground terminal T11. The inter-power-supply ESD protection circuit 4d is connected to the internal circuit L4 in parallel so as to be reverse-biased between the power supply terminal T4 and the ground terminal T11. As the inter-power-supply ESD protection circuit 4d, for example, the circuit shown in FIG. 4 can be used. The inter-power-supply ESD protection circuit 4d protects the internal circuit L4 when ESD is applied between the power supply terminal T4 and the ground terminal T11.

The ESD protection circuit 8b between different power supplies is a bidirectional diode which connects a power supply system including a voltage applied between the power supply terminal T3 and the ground terminal T10 to another power supply system including a voltage applied between the power supply terminal T4 and the ground terminal T11. As the ESD protection circuit 8b, for example, the circuit as shown in FIG. 6 can be used in which the diodes D1, D2 directing in opposite directions are connected to each other in parallel. Alternatively, the resistor R as shown in FIG. 7 can be used. The ESD protection circuit 8b between different power supplies protects the internal circuits L3, L4 when ESD is applied between any one of the power supply terminal T3 and the ground terminal T10 and any one of the power supply terminal T4 and the ground terminal T11.

The input-output-terminal ESD protection circuits 3c and 5c are connected to each other in series. In addition, these serially-connected input-output-terminal ESD protection circuits 3c and 5c are connected to the internal circuit L3 in parallel so as to be reverse biased between the power supply terminal T3 and the ground terminal T10. Moreover, a node between the input-output-terminal ESD protection circuits 3c and 5c is connected to the input-output terminal T9 of the package board 1 through a signal terminal S4 of the LSI chip 22. As the input-output-terminal ESD protection circuit 3c, for example, the diode-connected N-channel MOS transistor NM shown in FIG. 3 can be used. The input-output-terminal ESD protection circuit 3c protects the internal circuit 3L when ESD is applied between the input-output terminal T9 and the ground terminal T10. As the input-output-terminal ESD protection circuit 5c, for example, the diode-connected P-channel MOS transistor PM shown in FIG. 5 can be used. The input-output-terminal ESD protection circuit 5c protects the internal circuit L3 when ESD is applied between the input-output terminal T9 and the power supply terminal T3.

The test-terminal ESD protection circuits 3d and 5d are connected to each other in series. In addition, these serially-connected test-terminal ESD protection circuits 3d and 5d are connected to the internal circuit L3 in parallel so as to be reverse biased between the power supply terminal T3 and the ground terminal T10. Moreover, a node between the test-terminal ESD protection circuits 3d and 5d is connected to the test terminal T8 of the package board 1 through the signal terminal S3 of the LSI chip 22. As the test-terminal ESD protection circuit 3d, for example, the diode-connected N-channel MOS transistor NM shown in FIG. 3 can be used. The test-terminal ESD protection circuit 3d protects the internal circuit L3 when ESD is applied between the test terminal T8 and the ground terminal T10. As the test-terminal ESD protection circuit 5d, for example, the diode-connected P-channel MOS transistor PM shown in FIG. 5 can be used. The test-terminal ESD protection circuit 5d protects the internal circuit L3 when ESD is applied between the test terminal T8 and the power supply terminal T3.

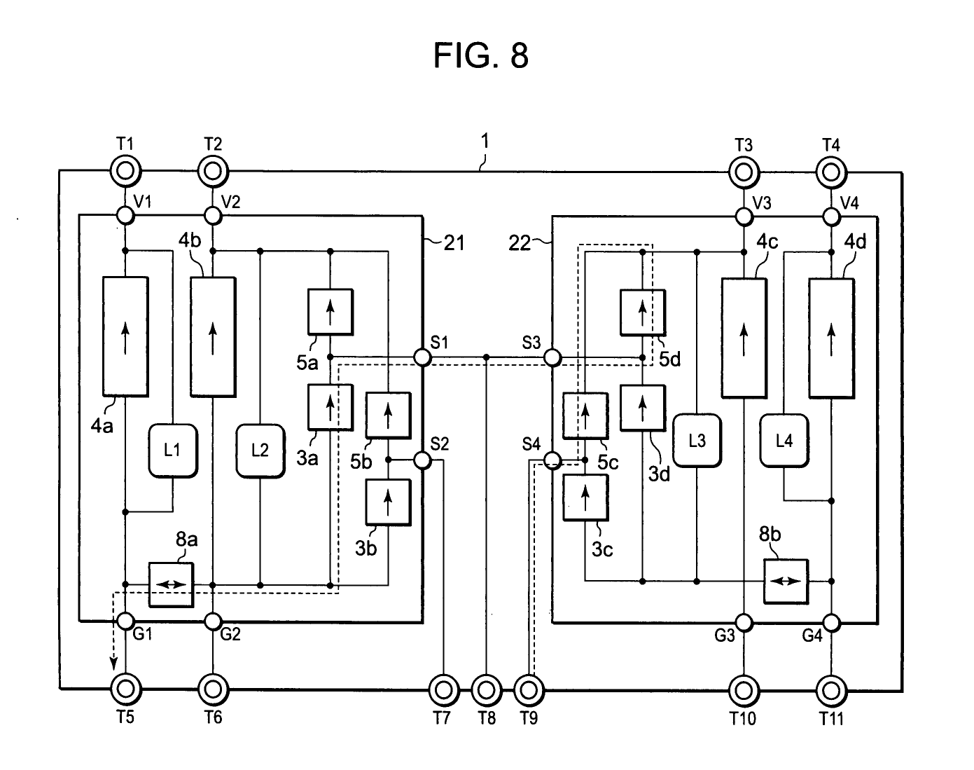

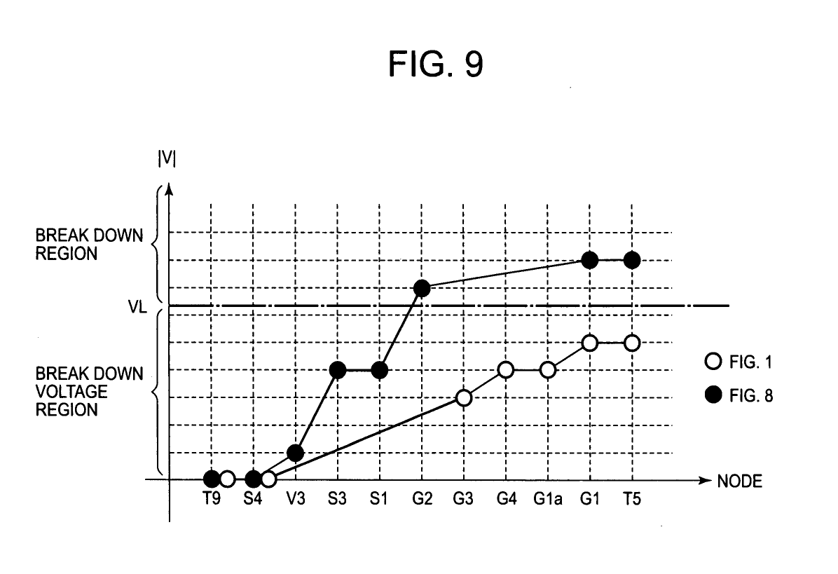

Next, a comparative example of the exemplary embodiment is described by using FIG. 8. FIG. 8 is a circuit diagram of an SiP according to the comparative example. The SiP shown in FIG. 8 is different from the SiP shown in FIG. 1 in that the inter-chip ESD protection circuit 9 in FIG. 1 is not included in FIG. 8. The other configurations are the same as those of FIG. 1, and the description thereof is omitted.

Next, a mechanism of preventing electrostatic breakdown in the SiP according to the exemplary embodiment is described by comparing the SiPs of FIG. 1 and FIG. 8 using FIG. 9. As shown by dotted arrows in FIG. 1 and FIG. 8, suppose the case where, in each SiP, the ground terminal T5 of the LSI chip 21 is grounded, and where ESD is applied to the input-output terminal T9 of the LSI chip 22. The graph shown in FIG. 9 shows absolute values of potentials at individual nodes when the potential of the input-output terminal T9 is used as a reference. The horizontal axis indicates the nodes, and the vertical axis indicates the absolute value of the potential.

In the SiP of FIG. 8, ESD reaches the ground terminal T5 from the input-output terminal T9 through the terminal S4, the input-output-terminal ESD protection circuit 5c, the test-terminal ESD protection circuit 5d, the terminal S3, the terminal S1, the test-terminal ESD protection circuit 3a, the ESD protection circuit 8a between different power supplies, and the terminal G1. Here, as shown in FIG. 9, for example, suppose that, when ESD passes through a forward-biased protection circuit, the potential increases by 1 scale, whereas, when ESD passes through a reverse-biased protection circuit, the potential increase by 3 scales. This corresponds to the case where the resistance of the reverse-bias protection circuit is three times higher than that of the forward-bias protection circuit, with the current being constant. As a result, in the case of the SiP of FIG. 8, ESD passes through the two reverse-biased protection circuits. Accordingly, the potential exceeds a breakdown voltage potential VL at the terminal G2, as a breakdown region, which may break down the internal circuits L1 and L2.

On the other hand, in the case of the SiP of FIG. 1, ESD reaches the ground terminal T5 from the input-output terminal T9 through the terminal S4, the input-output-terminal ESD protection circuit 3c, the ESD protection circuit 8b between different power supplies, the terminal G4, the terminal G1a, the inter-chip ESD protection circuit 9, and the terminal G1. As a result, in the case of the SiP of FIG. 1, ESD passes through only one reverse-biased protection circuit. For this reason, the potential does not exceed a breakdown voltage potential VL as a breakdown voltage (no breakdown) region. Accordingly, the breakdown of the internal circuits L1 and L2 can be prevented.

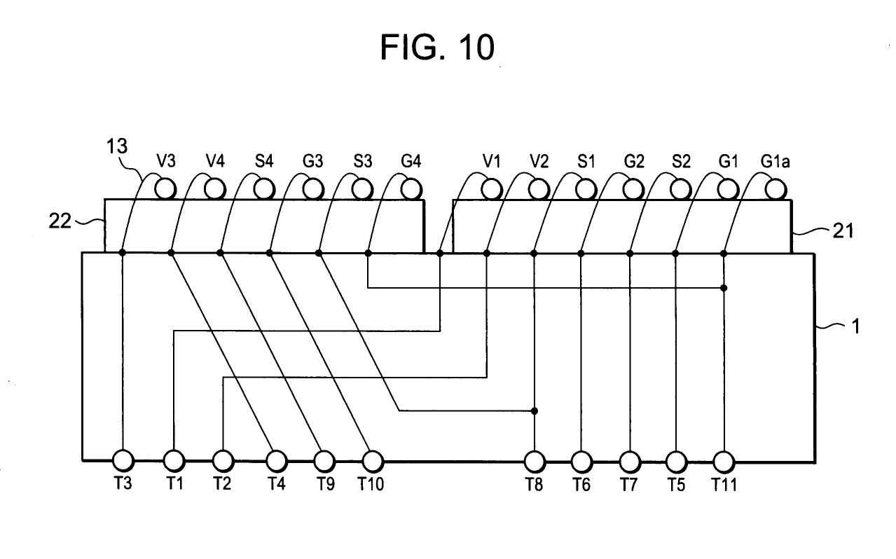

As a package corresponding to the circuit diagram of FIG. 1, an MCP of FIG. 10 can be used in addition to the SiP of FIG. 2. In the MCP of FIG. 10, the LSI chip 21 and the LSI chip 22 are separately mounted on the package board 1. The connection relationship of terminals is the same as that of FIG. 1, and the description thereof is omitted.

### Second Exemplary Embodiment

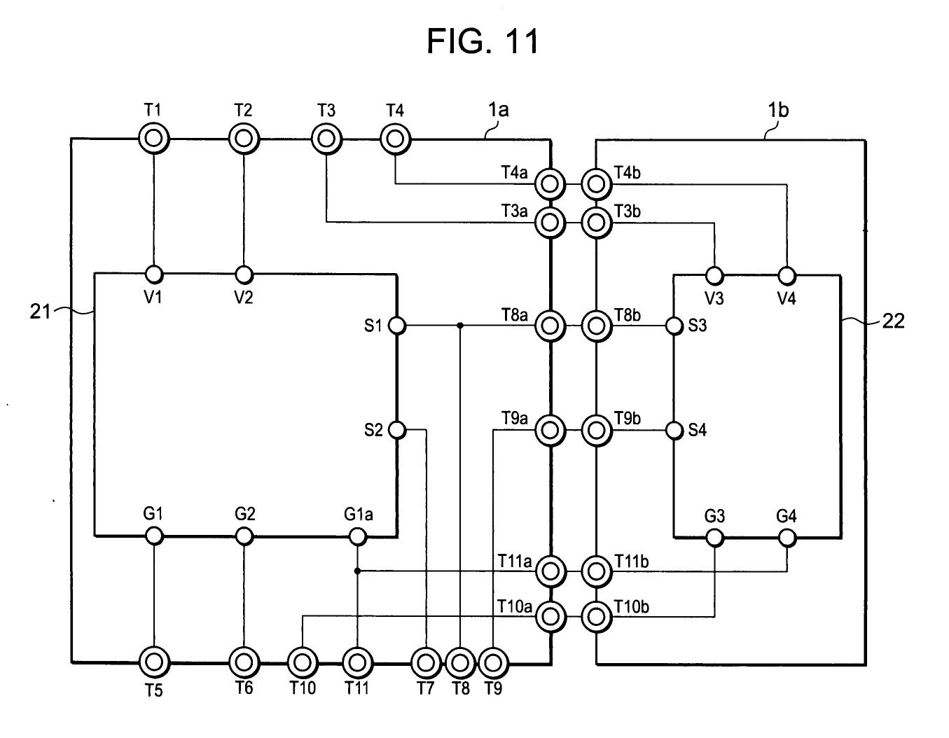

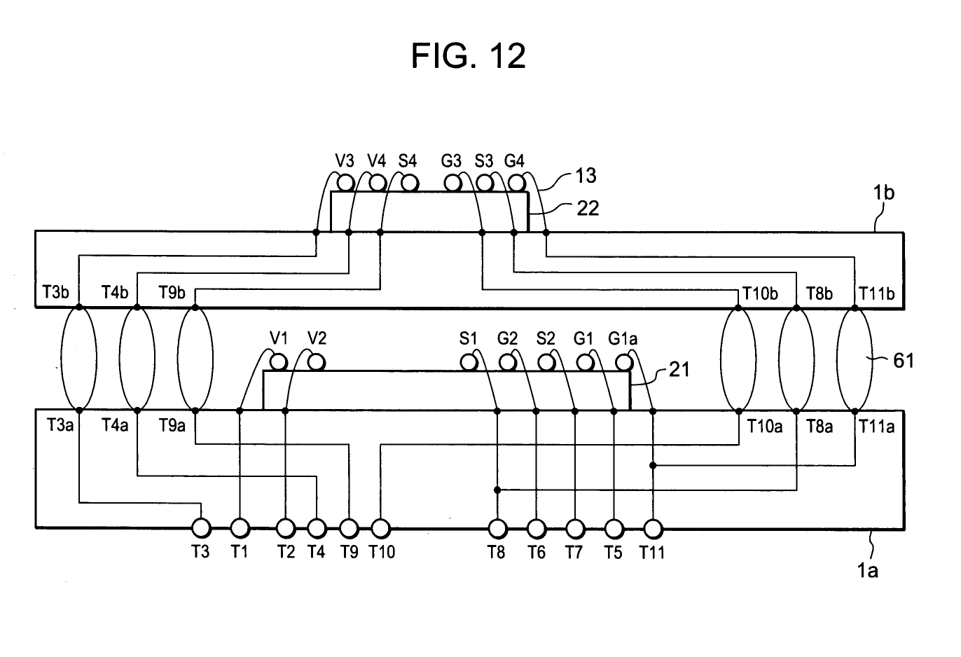

FIG. 11 is a circuit diagram of a PoP according to a second exemplary embodiment. FIG. 12 is a side view of the PoP according to the second exemplary embodiment. As shown in FIG. 11 and FIG. 12, the PoP includes package boards 1a, 1b, an LSI chip 21, and an LSI chip 22. A signal terminal S1 of the LSI chip 21 and a signal terminal S3 of the LSI chip 22 are connected to each other through a terminal T8a of the package board la and a terminal T8b of the package board 1b, so that signals are transmitted and received between the LSI chips. As shown in FIG. 12, the LSI chip 21 is mounted on the package board 1a to form a first package. Moreover, the LSI chip 22 is mounted on the package board 1b to form a second package. In addition, the second package is mounted on the first package. The first and second packages are connected to each other by a solder 61.

Here, the package board 1a includes power supply terminals T1 to T4, ground terminals T5, T6, T10, T11, input-output terminals T7, T9, and a test terminal T8. Note that internal configurations of the LSI chip 21 and the LSI chip 22 are the same as those in the first exemplary embodiment, and are omitted in FIG. 11.

The power supply terminals T1 to T4 are terminals to which power supply potentials are applied after the PoP is mounted on an electronic device. In addition, as shown in FIG. 12, the power supply terminals T1 to T4 are formed on the back surface of the package board 1a. Moreover, the power supply terminals T1, T2 are respectively connected to terminals V1, V2 of the LSI chip 21 through a through hole, a wiring, a bonding wire 13, or the like of the package board 1a. The power supply terminals T3, T4 are respectively connected to terminals V3, V4 of the LSI chip 22 through a through hole, a wiring, and terminals T3a, T4a of the package board 1a, a solder 61, terminals T3b, T4b, a through hole, a wiring, a bonding wire 13, or the like of the package board 1b. Here, different power supply potentials are applied to the power supply terminal T1 and the power supply terminal T2. Similarly, different power supply potentials are applied to the power supply terminal T3 and the power supply terminal T4. For example, VDD1 is applied to the power supply terminals T1, T3 while VDD2 is applied to the power supply terminals T2, T4.

The ground terminals T5, T6, T10, T11 are terminals to which ground potentials are applied after the PoP is mounted on an electronic device. Moreover, as shown in FIG. 12, the ground terminals T5, T6, T10, T11 are formed on the back surface of the package board 1. The ground terminals T5, T6 are respectively connected to terminals G1, G2 of the LSI chip 21 through a through hole, a wiring on the package board 1a, the boding wire 13, or the like. Meanwhile, the ground terminals T10, T11 are respectively connected to terminals G3, G4 of the LSI chip 22 through a through hole, a wiring, and terminals T10a, T11a of the package board 1a, a solder 61, terminals T10b, T11b, a through hole, and a wiring, the bonding wire 13, or the like of the package board 1b.

In addition, the input-output terminal T7 is connected to a signal terminal S2 of the LSI chip 21. The input-output terminal T9 is connected to a signal terminal S4 of the LSI chip 22 through a terminal T9a of the package board la and a terminal T9b of the package board 1b.

An inter-chip ESD protection circuit is also formed inside the LSI chip 21. Accordingly, similar to the first exemplary embodiment, a step of mounting an inter-chip ESD protection circuit on the package board 1a is not needed. Thus, the total yield of the package product is also improved. In addition, a space for the mounting is not required, which results in the miniaturization. Moreover, at the same time, a noise between the chips can be blocked.

### Third Exemplary Embodiment

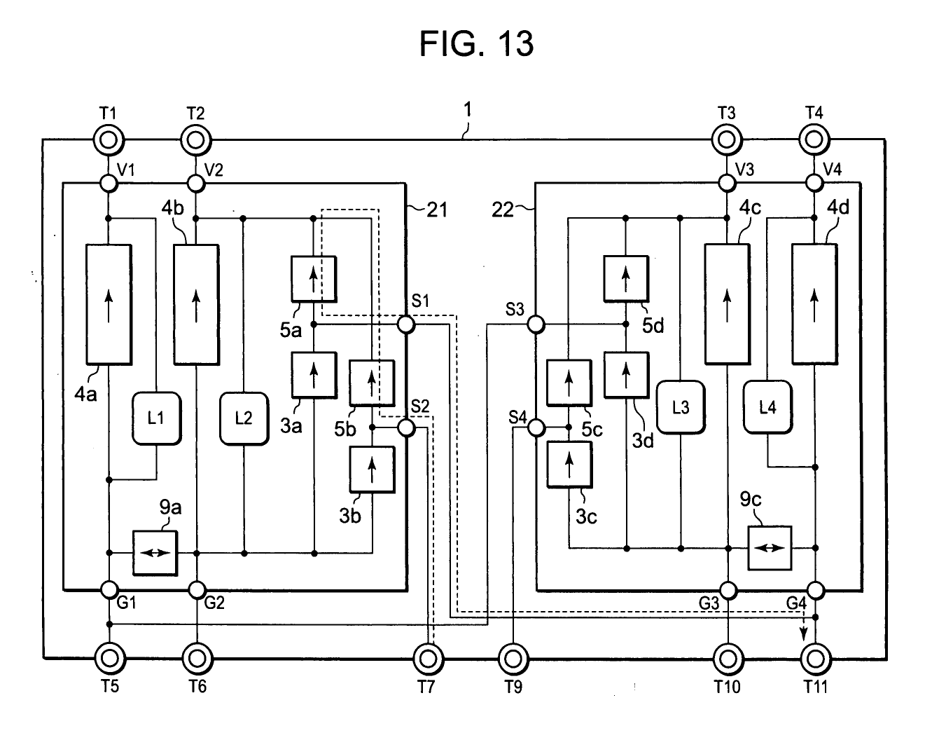

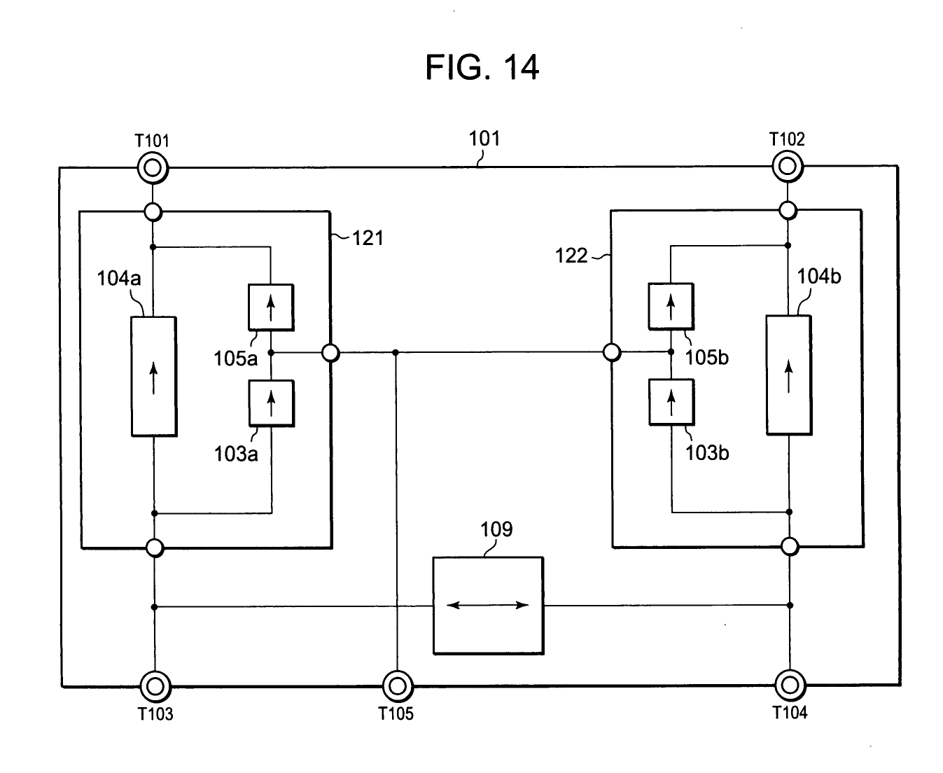

FIG. 13 is a circuit diagram of an SiP according to a third exemplary embodiment. The SiP shown in FIG. 13 is different from the SiP shown in FIG. 1 in that the inter-chip ESD protection circuit 9 in FIG. 1 is not included in FIG. 13. Instead of this, an extra signal terminal S1 of an LSI chip 21 is connected to a node between a ground terminal 11 and a terminal G4 of an LSI chip 22, while an extra signal terminal S3 of the LSI chip 22 is connected to a node between a ground terminal T5 and a terminal G1 of the LSI chip 21. Note that a signal line connecting the LSI chips to each other and a test terminal T8 are omitted for simplification. The other configurations are the same as those in First exemplary embodiment, and the description thereof is omitted.

For example, in a case where the ground terminal T11 of the LSI chip 2 is grounded, and where ESD is applied to the input-output terminal T7 of the LSI chip 1, the ESD follows the path shown in FIG. 13, and thus the electrostatic breakdown is prevented.

In the exemplary embodiment, the inter-chip ESD protection circuit 9 is not needed. Instead of this, the test-terminal ESD protection circuits 3, 5 provided to the extra signal terminal are effectively utilized. Accordingly, similar to First exemplary embodiment, a step of mounting an inter-chip ESD protection circuit on the package board 1 is not needed, also. Thus, the total yield of the package product is improved as well. In addition, a space for the mounting is not required, which results in the miniaturization. Moreover, at the same time, a noise between the chips can be blocked.

Further, it is noted that Applicant's intent is to encompass equivalents of all claim elements, even if amended later during prosecution.

What is claimed is:

1. A semiconductor package, comprising:
a first semiconductor chip;
a first internal circuit which operates, in the first semiconductor chip, at a voltage applied between a first high-potential side power supply terminal and a first low-potential side power supply terminal;
a second semiconductor chip;
a second internal circuit which operates, in the second semiconductor chip, at a voltage applied between a second high-potential side power supply terminal and a second low-potential side power supply terminal; and
a first electrostatic protection circuit which is placed in the first semiconductor chip, and which has one end connected to a node between the first internal circuit and the first low-potential side power supply terminal and has an other end connected to a node between the second internal circuit and the second low-potential side power supply terminal.

2. The semiconductor package according to claim 1, wherein the first electrostatic protection circuit includes a bidirectional diode.

3. The semiconductor package according to claim 1, wherein the first electrostatic protection circuit includes a resistor.

4. The semiconductor package according to claim 1, further comprising a second electrostatic protection circuit which is connected to the first internal circuit in parallel.

5. The semiconductor package according to claim 1, further comprising a third electrostatic protection circuit which is connected to the second internal circuit in parallel.

6. The semiconductor package according to claim 1, further comprising:
a third internal circuit which operates, in the first semiconductor chip, at a voltage applied between a third high-potential side power supply terminal and a third low-potential side power supply terminal; and
a fourth electrostatic protection circuit which is formed in the first semiconductor chip, and which has one end connected to a node between the first internal circuit and the first low-potential side power supply terminal and has an other end connected to a node between the third internal circuit and the third low-potential side power supply terminal.

7. The semiconductor package according to claim 6, wherein the fourth electrostatic protection circuit includes a bidirectional diode.

8. The semiconductor package according to claim 6, wherein the fourth electrostatic protection circuit includes a resistor.

9. The semiconductor package according to claim 1, wherein the first and second semiconductor chips are mounted on a single package board.

10. The semiconductor package according to claim 1, wherein:
the first semiconductor chip is mounted on a first package board;
the second semiconductor chip is mounted on a second package board; and
the second package board is mounted on the first package board.

11. A semiconductor package, comprising:
a first semiconductor chip;
a first internal circuit which operates, in the first semiconductor chip, at a voltage applied between a first high-potential side power supply terminal and a first low-potential side power supply terminal;
a second semiconductor chip; and
a second internal circuit which operates, in the second semiconductor chip, at a voltage applied between a second high-potential side power supply terminal and a second low-potential side power supply terminal, wherein:
a first signal terminal of the first semiconductor chip is connected to a node between the second internal circuit and the second low-potential side power supply terminal; and
a second signal terminal of the second semiconductor chip is connected to a node between the first internal circuit and the first low-potential side power supply terminal.

12. The semiconductor package as claimed in claim 11, wherein the first signal terminal includes a first test terminal and the second signal terminal includes a second test terminal.
